(19) United States
(12) Patent Application Publication
(10) Pub. No.: US 2026/0364843 A1
(43) Pub. Date: Nov. 19, 2026

(54) LIQUID FUME FOR TREATING WOOD

(71) Applicants: Robert Anthony SCHATZ, Hanover, PA (US); Christopher D. MILLS, Hanover, PA (US); Michelle Lynn MILLS, Hanover, PA (US); Mark J. SCHAUB, Hanover, PA (US); Robert Andrew SCHATZ, Hanover, PA (US)

(72) Inventors: Robert Anthony SCHATZ, Hanover, PA (US); Christopher D. MILLS, Hanover, PA (US); Michelle Lynn MILLS, Hanover, PA (US); Mark J. SCHAUB, Hanover, PA (US); Robert Andrew SCHATZ, Hanover, PA (US)

(21) Appl. No.: 19/679,009

(22) Filed: May 15, 2026

Related U.S. Application Data
(60) Provisional application No. 63/807,030, filed on May 16, 2025.

(51) Int. Cl. B27K 3/02; B27K 3/16; B27K 3/36

(52) U.S. Cl. CPC B27K 3/0271; B27K 3/0207; B27K 3/16; B27K 3/36

(57) ABSTRACT

A liquid fume composition, consisting essentially of liquid ammonia, methanol, and color dye.

### CROSS REFERENCE TO RELATED APPLICATION

This application claims the benefit of provisional application 63/807,030, filed on May 16, 2025, and incorporated herein in its entirety.

### FIELD OF THE INVENTION

The invention related to treating wood with an ammonia solution to affect the appearance of the wood.

### BACKGROUND OF THE INVENTION

One popular choice of reclaimed wood is wood from old barns. This wood is subjected to long time exposure to ammonia fumes released by animal waste, providing the wood a distinctive look. However, the supply of reclaimed barn wood does not meet the potential demand for wood having this distinctive look. Therefore, a process of mimicking the look of reclaimed barn wood has been developed including exposing the wood to ammonia fumes in a chamber.

To meet the demand for fumed wood that cannot be met by reclaimed wood, new lumber can be fumed. Small pieces can be fumed in an enclosed box or a sealed and larger pieces of wood can be placed in a plastic tent or a sealed room. The wood is placed inside the tent, room or containers with liquid ammonia and then sealed. The ammonia releases fumes inside the enclosed space, and starts the chemical fuming process on the wood. This is called aeromantic fuming. This process requires a large volume of sealed enclosure space and has a tendency to be very inconsistent. This is time consuming in comparison to the invention being considered.

### SUMMARY OF THE INVENTION

The present invention uses a liquid ammonia composition to create fumed new lumber. The liquid ammonia composition has at least 70% ammonia and can include methanol to control the concentration of dye to impart color to the wood. One example of the composition has 70-80% ammonia, 10-20% methanol and 10%+/−dye. All percentages are percent by volume.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### DETAILED DESCRIPTION OF THE INVENTION

The liquid ammonia composition has an ammonia base, meaning that ammonia has the largest percent by volume of all component. Dye added to the ammonia provides additional and adjustable color to the treated wood and the color and hue can be modified by the type and amount of dye added. Applying the ammonia composition to the wood and allowing the composition to penetrate the wood alters the visual appearance of the wood, even if dye is not added to the composition.

One composition includes 70-80% ammonia, 10-20% methanol and 10% dye. However, dye can be excluded from the composition, resulting in 77.7%-89% ammonia and 11-22.3% methanol when no dye is used.

The composition is applied to cut, untreated wood. For the purposes of this disclosure, cut untreated wood refers to wood that has been cut to a size and shape suitable for its final intended use, such as in flooring, paneling or furniture, but that has not been treated with dyes, stains, sealants or other chemical treatments.

The composition is applied as a liquid to the wood being treated. The treatment is completed once the liquid has dried, having been absorbed by the wood or evaporated. The treatment time is significant less than the conventional method of aeromatic fuming which requires a minimum of eight hours. Applying the liquid includes immersion, spraying, brushing, rolling and ragging. Therefore, the application process does not require extensive or specialized equipment. The treated wood has superior color consistency, when compared to traditional aeromatic fuming.

The wood to be treated is considered raw lumber, meaning that the wood has been cut into panels, beams and other shapes suitable for its ultimate purpose but have not otherwise been treated. Preferably, the wood is treated before being installed, such as in flooring, walls, ceiling of a building or as an element in a piece of furniture. The treatment can be on a single surface that remains exposed after installation, opposite surface can be treated, all surfaces can be treated or some surfaces can be left untreated when these surfaces are certain to not be visible after installation.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid fume composition, consisting essentially of:
liquid ammonia,
methanol; and
color dye.

2. The liquid fume of claim 1, wherein ammonia is at least 70% of the liquid fume composition.

3. A method of treating wood, comprising
cutting untreated lumber to a size and shape suitable for an end use;
exposing at least one surface to a liquid fume, the liquid fume comprising ammonia, methanol and dye.

4. The method of claim 3, wherein exposing at least one surface to a liquid fume comprising applying the liquid fume to the at least one surface with a brush, roller, rag, or spray.

5. The method of claim 3, wherein exposing at least one surface to a liquid fume comprising immersion of the untreated lumber in the liquid fume.

6. A liquid fume composition, comprising:
70-80% liquid ammonia;
10-20% Methanol and
color dye.
